(19) United States
(12) Patent Application Publication
(10) Pub. No.: US 2004/0150687 A1
(43) Pub. Date: Aug. 5, 2004

(54) Printing apparatus, information processing apparatus, printing system, printing method, printing medium selection method, program, and storage medium

(76) Inventor: Ichiro Matsuyama, Kanagawa (JP)

Correspondence Address: MORGAN & FINNEGAN, L.L.P., 345 PARK AVENUE, NEW YORK, NY, 10154, US

(21) Appl. No.: 10/762,600

(22) Filed: Jan. 21, 2004

(30) Foreign Application Priority Data
Jan. 22, 2003 (JP) 2003-013979

(51) Int. Cl. B41J 29/38

(52) U.S. Cl. 347/16; 347/104

(57) ABSTRACT

The present invention allows a type of printing medium, which is applicable to a type of printing material used for printing an image and yields favorable printing results, to be selected as the type of printing medium, on which the image is to be printed, when the image is to be printed by selectively using a plurality of types of printing materials. To accomplish this function, in one preferred mode, the result of discriminating the type of printing material used for printing is collated with information on an applicability relation between the type of printing material and the type of printing medium.

This application claims priority from Japanese Patent Application No. 2003-013979 filed Jan. 22, 2003, which is incorporated hereinto by reference.

### BACKGROUND OF THE INVENTION

1. Field of the Invention

The present invention relates to a printing apparatus capable of printing an image on a printing medium of a plurality of types (plain paper, coated paper, OHP (Over Head Projector) transparencies, glossy paper, glossy film, and the like) by selectively using printing materials of a plurality of types (for example, a pigment ink and a dye ink). The present invention, further relates to an information processing apparatus connected to the printing apparatus, a printing system including the printing apparatus and the information processing apparatus, a printing method, a method for selecting the printing medium used in the printing apparatus, a program for making possible the selection, and a storage medium storing the program.

2. Description of the Related Art

Generally speaking, a printing system composed of a host computer (an information processing apparatus) and a printer (a printing apparatus) performs various editing tasks in accordance with a variety of application programs started by the host computer. An output is then produced of data that has undergone these editing operations as printing job data to the printer or a network printer connected to the host computer via an interface. The printing job data is in this manner printed.

When the printer prints the printing job data in a printing system such as that described above, a printer driver started on the host computer displays a dialog and the like on the host computer before the application program produces the output of the data. This allows a user to set the type and size of the printing medium used for printing, a medium feeding port from which the printing medium is fed, and other parameters defining the printing job. There are also some printing systems, in which a utility program started on the host computer displays a dialog or the like when the host computer receives a notice of a status change from the printer, such as an error occurring in the printer. The user thereby gains information on the specific details of the error that has occurred, a printer status, a printing job status, and the like.

There is available, for example, as a type of printer making up such a printing system as that described in the foregoing, a printer employing an ink jet printing method (hereinafter referred to as the “ink jet printer”). In a typical ink jet printer, ink as a printing material is ejected from a printing head used in a printing portion towards a printing medium, such as paper, film, or the like, to produce an image on the medium. The ink jet printer has a number of advantages over printers employing other printing methods. In addition to the features of a body built more compactly and a lower cost, the ink jet printer can print high definition images at high speeds. The printer is also capable of printing color images using ink of many different colors.

In a serial scan type, taken as an example of the ink jet printer, a carriage on which the printing head is mounted is made to travel reciprocally in a main scanning direction relative to the printing medium, such as paper, loaded in a paper feeding portion and transported to a printing position. While the carriage makes this reciprocating motion, printing of one line is accomplished. The printing head is provided with a plurality of ejection ports (nozzles) arranged in a direction of transporting the printing medium. During a printing operation, the printing medium remains stationary. When printing of one line is completed and while the printing head thereafter returns to a home position thereof, a transport motor feeds the printing medium in pitches of a predetermined amount in the transporting direction. The printing medium is then brought to a stop again. Through repeated operations of this sequence, an image is printed on the entire printing area of the printing medium. The ink as the printing material ejected from the printing head is supplied from an ink tank at the printing portion. A plurality of paper sensors are provided along a transport path of the printing medium. The use of these paper sensors permits detection of various events as follows Specifically, the sensors detect, to name a few: whether or not there is paper at the paper feeding port; whether or not a delay jam has occurred as a result of the printing medium failing to reach the position of a paper sensor within a predetermined period of time; whether or not a stagnant jam has occurred as a result of the printing medium failing to move past the position of a paper sensor within a predetermined period of time; and whether or not a skew feed has occurred, in which the printing medium is transported an a predetermined angle relative to the transport direction. A cutter may be provided after the printing position (on a downstream side in the transport direction) along the transport path of the printing medium. If a printing medium of a roll form is used, the cutter may be used to cut the printing medium to an arbitrary length so that the cut length of printing medium is fed out.

The ink jet printer involves possible degradation of printing quality arising from various reasons. The reasons specifically include: part-to-part variations in the nozzle occurring in manufacturing processes of the printing head; ejection sequence of ink of a plurality of colors ejected at a single location in the printing medium; and an error produced in pitch feed of the printing medium. Generally speaking, printers have trade-off between printing speed and printing quality. Patent Literature 1 discloses a technique of multi-pass printing, in which an image is completed by two or more printing scan motions for a single printing area. The multi-pass printing is disclosed as a solution to the problem of uneven density in the ink jet printer. In the multi-pass printing, when the number of passes is increased, the printing quality is increased, though the printing speed is decreased. Unidirectional printing, in which the image is printed by a carriage's printing scan motion in one direction only, may here be compared with bidirectional printing, in which the image is printed by the carriage's reciprocal printing scan motion. While the printing speed in the former unidirectional printing is lower than in the latter bidirectional printing, the printing quality in the former is higher than in the latter. In addition, when the speed with which the carriage scans and the speed with which the ink is ejected from the printing head (ejection frequency) are increased, it results in the printing quality being degraded due to a greater effect from nozzle-to-nozzle variations, though the printing speed is increased.

Many printing systems using the ink jet printers work as follows to print the image. Specifically, the image information having multiple gradation levels edited with a variety of application programs run on the host computer is printed on the printing medium as binary dot data for ink of each of different colors with a printing resolution achieved based on a nozzle pitch in the printing head of the printer. Such systems therefore perform the following three processes: specifically, a color conversion process, in which a color conversion table is used to convert color data to a corresponding ink color; a gradation conversion process, in which the multiple gradation levels are converted to binary data; and a resolution conversion process, in which the data are converted to the printing resolution. Available as image processing methods that perform the gradation conversion and resolution conversion are an error diffusion method and a dither method. The former error diffusion method is more complicated and takes a longer time in performing the processes, though yielding a higher printing quality. For example, the processing resolution involved in performing such image processing is set lower than the printing resolution. Output results of such image processing are then subjected to resolution conversion, thereby producing dot data with the printing resolution. When the processing resolution involved in image processing is decreased, the processing speed is increased, though the printing quality is decreased.

In printing by the ink jet printer, a type of printing medium (called coated paper) may be used, in which a coating layer is provided on the surface thereof to enhance absorption of ink. As compared with the common printing medium, such as plain paper, the coated paper offers a good printing quality exhibiting no ink bleeding and higher tone reproduction performance. The use of a type of printing medium having a glossy surface (glossy paper, glossy film) makes appearance of the printed image even better. In cases where printing results are used outdoors, a special type of printing medium having weathering resistance may be used. The printing media such as those cited above are more expensive than the ordinary printing media, and a higher printing quality is required of these printing media even with a lower printing speed. If any of such expensive printing media is specified as a printing specifications parameter, therefore, printing control parameters including the number of passes, the pass direction, the scanning speed, the ejection frequency, the image processing method, and the processing resolution that will expectantly produce a higher printing quality are selected even with a low printing speed. If, on the other hand, the printing quality is not at a premium and only the printing results are quickly needed when a relatively inexpensive printing medium is used, printing control parameters for a higher printing speed with even a slightly degraded printing quality are selected.

Different types of printing media have varying capacities of ink absorption. It is therefore necessary to adjust the amount of ink of each color ejected according to the printing medium used. This adjustment is in many cases made by changing the color conversion table. In addition, the printing media have different coefficients of friction according to the material used and surface treatment applied. This makes it necessary to adjust the amount of pitch feed in the transport direction as a printing control parameter. These amounts to be adjusted are previously determined according to the different types of printing media used in the printer and the corresponding adjustment data are retained in the printer or the host computer. In accordance with the type of printing medium specified as the printing specifications parameter, the appropriate color conversion table and the pitch feed amount are selected. Should a wrong color conversion table or a wrong pitch feed amount be selected not corresponding to the printing medium selected for use, the resultant printing quality is not what has been expected.

There are known some printing systems that provide a solution to such a problem as that cited above. Specifically, in such a printing system, it is determined whether or not the type of printing medium specified as the printing specifications parameter for the printing job data coincides with the printing medium loaded in the printer. If it is determined that there is discrepancy between the two, the printing system gives a warning on a panel of the printer or gives a warning notice to the host computer. The host computer, on receipt of the warning notice, directs the utility running thereon to display a warning message dialog. The host computer thereby prompts the user to check to see if a wrong type of printing medium is being used.

Patent Literature 2 discloses a method for discriminating the type of printing medium loaded in the printer. This method automatically discriminates the type of printing medium without degrading the printing results. Patent Literature 3 discloses a method, in which a unique identification number is assigned for each of different types of printing media and the printer reads the specific identification number to determine the type of printing medium. In either method, however, it is necessary to add identification information of some form to the printing medium, which could result in printing results being degraded, or a manufacturing cost of the printer main unit or printing media being increased. There is also available a printer that lets the user set the type of printing medium from the control panel thereof when he or she loads the printing medium in the printer. This requires no special processing on the printing media.

The dye ink and the pigment ink are available as the ink used in the ink jet printer. The “dye ink” refers to the type of ink that uses dyes for a coloring agent thereof, while the “pigment ink” refers to the type of ink that uses pigments for a coloring agent thereof. The dye ink can produce a printed matter showing vivid colors, used very often for printing, for example, photos or the like. If the pigment ink is used, a printed matter having no ink bleeding and offering outstanding weathering resistance can be produced. The pigment ink is used for printing, for example, official documents and posters to be posted outdoors. The ink of these two types may be used in combination at the same time according to the printing color involved. For example, one type of printer uses the pigment ink only for the black and the dye ink for other colors. Another type of printer is capable of selectively using the dye ink or the pigment ink according to the application of the printed matter. Patent Literature 4 discloses a method for controlling the printer that selectively uses the dye ink or the pigment ink. This method uses different driving signals according to the type of ink to be used.

[Patent Literature 1]

Japanese Patent Application Laid-open No. 2002-144552

[Patent Literature 2]

Japanese Patent Application Laid-open No. 9-030073 (1997)

[Patent Literature 3]

Japanese Patent Application Laid-open No. 11-191056 (1999)

[Patent Literature 4]

Japanese Patent Application Laid-open No. 2001-253096

Depending on the material used in, and the surface treatment applied to, the printing medium used for printing, however, printing may be possible using both the dye ink and pigment ink, or good printing results may be produced when using only either the dye ink or pigment ink. A printing quality as expected may not be obtained if an inadequate combination is used of the ink as the printing material and the printing medium for printing, wasting the printing medium and printing material used. This can be a big problem when an expensive printing medium is used for printing.

### SUMMARY OF THE INVENTION

It is therefore an object of the present invention to provide a printing apparatus capable of selecting, when printing an image by selectively using printing materials of a plurality of types (for example, a pigment ink and a dye ink), a type of printing medium, as the type of printing medium on which the image is printed (for example, plain paper, coated paper, glossy paper, or glossy film), that allows a favorable printing result to be obtained as applied to the printing material used for printing, an information processing apparatus connected to the printing apparatus, a printing system including the printing apparatus and the information processing apparatus, a printing method, a method for selecting the printing medium used in the printing apparatus, a program for making possible the selection, and a storage medium storing the program.

In the first aspect of the present invention, there is provided a printing apparatus capable of printing an image on printing media of a plurality of types by selectively using printing materials of a plurality of types, comprising:

a discrimination portion for discriminating the type of the printing material used for printing of an image;

a storage portion for storing information on applicability between different types of the printing materials and different types of the printing media; and

a collation portion for collating the type of the printing material discriminated by the discrimination portion with information stored in the storage portion.

In the second aspect of the present invention, there is provided an information processing apparatus connected to a printing apparatus capable of printing an image on printing media of a plurality of types by selectively using printing materials of a plurality of types, comprising:

an input portion for allowing an input to be made of the type of the printing medium used by the printing apparatus;

a storage portion for storing information on applicability between different types of the printing materials and different types of the printing media; and

a collation portion for collating the type of the printing material input from the input portion with information stored in the storage portion.

In the third aspect of the present invention, there is provided a printing system including a printing apparatus capable of printing an image on printing media of a plurality of types by selectively using printing materials of a plurality of types and an information processing apparatus connected to the printing apparatus, comprising:

a discrimination portion for discriminating the type of the printing material used by the printing apparatus;

a storage portion for storing information on applicability between different types of the printing materials and different types of the printing media; and

a collation portion for collating the type of the printing material discriminated by the discrimination portion with information stored in the storage portion.

In the fourth aspect of the present invention, there is provided a method for selecting a printing medium from among a plurality of types of printing media, on which an image is printed, when printing the image by selectively using printing materials of a plurality of types, comprising the steps of:

discriminating the type of the printing material used for printing; and

displaying, as reference information for selecting the printing medium, on which the image is printed, the type of the printing medium that is adaptable at least to the type of the printing material discriminated.

In the fifth aspect of the present invention, there is provided a program for selecting a printing medium from among a plurality of types of printing media, on which an image is printed, when printing the image by selectively using printing materials of a plurality of types, comprising the processes executed by a computer of:

discriminating the type of the printing material used for printing; and

displaying, as reference information for selecting the printing medium, on which the image is printed, the type of the printing medium that is adaptable at least to the type of the printing material discriminated.

In the sixth aspect of the present invention, there is provided a computer-readable storage medium storing the program of the fifth aspect of the present invention.

In the seventh aspect of the present invention, there is provided a method for printing an image on printing media of a plurality of types by selectively using printing materials of a plurality of types, comprising the steps of:

discriminating the type of the printing material used for printing;

displaying, as reference information for selecting the printing medium, on which the image is printed, the type of the printing medium that is adaptable at least to the type of the printing material discriminated;

selecting one printing medium from among the plurality of the printing media displayed by the displaying process; and

effecting printing on the printing medium selected using the printing material discriminated.

According to the present invention, it is possible to select the type of printing medium that, as the type of printing medium on which the image is printed, allows the favorable printing result to be obtained in accordance with the printing material used for printing of the image. This is accomplished by checking the result of determining the type of printing material used for printing against the information on applicability between the type of printing material and the type of printing medium. This avoids a case, in which the image is printed using a printing material and a printing medium that are not mutually applicable to each other.

The above and other objects, effects, features and advantages of the present invention will become more apparent from the following description of embodiments thereof taken in conjunction with the accompanying drawings.

### BRIEF DESCRIPTION OF THE DRAWINGS

FIG. 1 is a block diagram showing a printing system according to a first embodiment of the present invention;

FIG. 2 is a block diagram showing a hardware configuration of a controller portion shown in FIG. 1;

FIG. 3 is a block diagram showing a software configuration of the controller portion shown in FIG. 1;

FIG. 4 is an explanatory diagram showing a table retained by a manager control portion shown in FIG. 3;

FIG. 5 is an external view showing a printer of FIG. 1;

FIG. 6 is an external view showing a panel operation portion shown in FIG. 5;

FIG. 7A is a flowchart showing changes in typical display screens given in accordance with operations performed on the panel operation portion shown in FIG. 5, and FIG. 7B is a flowchart showing changes in another example of display screens given in accordance with operations performed on the panel operation portion shown in FIG. 5;

FIG. 8 is an explanatory diagram showing a typical dialog displayed by a printer driver in the host computer of FIG. 1; and

FIG. 9 is a flowchart showing changes in typical display screens given in accordance with operations performed on the panel operation portion according to a second embodiment of the present invention.

### DETAILED DESCRIPTION OF PREFERRED EMBODIMENTS

The preferred embodiments of the present invention will be described with reference to the accompanying drawings.

### First Embodiment

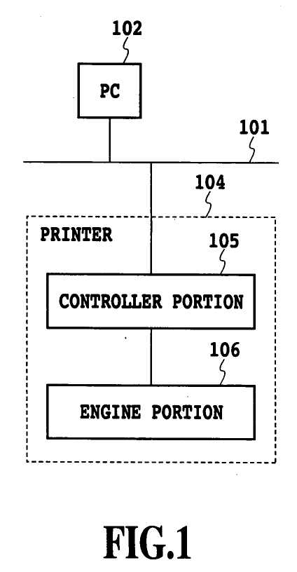

FIG. 1 is a block diagram showing a printing system including a printing apparatus and an information processing apparatus according to a first preferred embodiment of the present invention. Referring to FIG. 1, a printer (a printing apparatus) 104 is connected to a host computer (an information processing apparatus) 102 by way of a communication bus 101, such as Ethernet (a registered trademark), IEEE (Institute of Electrical and Electronic Engineers) 1394, or an USB (Universal Serial Bus).

The host computer 102 is provided with a CPU, a ROM, a RAM, a display device, and an input device not shown and an operating system (OS) controls system operations. The CPU operates various types of application programs read from a storage device not shown, and a printer driver and a utility corresponding to the printer 104. Before the application produces an output of data, the printer driver run on the host computer 102 displays a dialog and the like on the host computer 102. This allows a user to set printing specifications parameters that may include the type of printing medium, size of the printing medium, a medium feeding port from which the printing medium is fed, and a printing quality.

Printing job data output by the printer driver includes a printing control command for setting the printing specifications parameters including the information indicating the type of printing medium, a color conversion table, and image information of multiple gradation levels. The information indicating the type of printing medium, as the term is herein used, refers to the information that uniquely identifies the material of the printing medium and the surface treatment applied thereto. This information is an identification number assigned for each of different types of printing media, such as, for example, plain paper, coated paper, glossy paper, glossy film, and the like. The utility asks the printer 104 for status information on the printing job and the apparatus and outputs thereto a management command for maintenance of the apparatus. On receipt of a response to the inquiry, the utility displays a dialog showing the status of the printer 104 and that of the printing job.

In addition, a control command for filing and deletion is previously output with the host computer 102 as a notice recipient. A dialog is thereby displayed when a status change, such as when an error occurs, is received from the printer. The dialog lets the user know details of the error that has occurred or the status of the printer or the printing job. The data acquired from the printer 104 includes the name of the apparatus, to which information on the result of determining whether an ink tank loaded in a printing portion of the printer 104 is for the dye ink or the pigment ink is appended. For example, if the dye ink is being used, the name of the apparatus is “Large Format W7200” and, if the pigment ink is being used, the name of the apparatus is “Large Format W7200PG.”

The printer 104 employing the ink jet printing method includes a controller portion 105 and an engine portion 106. The printer 104 produces an output of an image, characters, a graphics image, or the like on the printing medium that comes in various sizes based on the printing job data sent thereto from the printer driver of the host computer 102 via the communication bus 101.

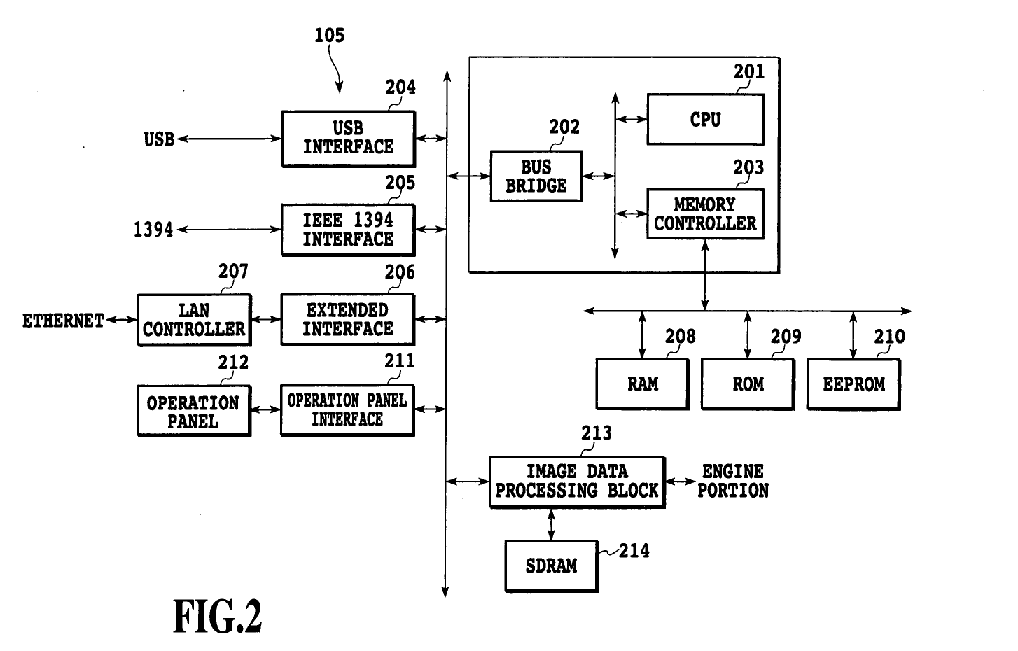

FIG. 2 is a block diagram showing schematically a configuration of the controller portion 105. The controller portion 105 is connected to the host computer 102 through the communication bus 101 by way of a USB interface 204, an IEEE 1394 interface 205, or a LAN controller [that is, an Ethernet (a registered trademark) interface] mounted on an extended interface 206. A CPU 201 accesses a ROM 209 storing a control program, an EEPROM 210 storing a control program, a processing program, and data of various types of constants that can be updated, and a RAM 208 storing printing job data and control commands received from the host computer 102. The CPU 201 thereby controls the controller portion 105 based on the information stored in these memories.

Specifications information input using keys on an operation panel 212 is transmitted to the CPU 201 by way of an operation panel interface 211. Commands issued from the CPU 201 control LED indications and an LCD display given on the operation panel 212 by way of the operation panel interface 211. The image information is expanded to dot data. An image data processing block 213 converts the dot data to each of different ink colors using the color conversion table and performs image processing. The resultant data is output to the engine portion 106. Various commands and status information are transferred to or from the controller portion 105 and the engine portion 106 by way also of the image data processing block 213.

The engine portion 106 is provided with a CPU, a ROM, a RAM, a printing head, a carriage, a transport motor, a cutter, a paper sensor, and an ink tank type discrimination sensor not shown. The CPU controls the printing head, the transport motor, the carriage, and cutter to effect a printing operation. The CPU performs these control operations based on the control program stored in the ROM, the ink color dot data or the various commands stored in the RAM as they are input to a data reception portion not shown from the image data processing block 213 of the controller portion 105, and the information on the printing medium detected and input by the paper sensor. The various commands include setting of a printing control parameter and execution of maintenance. The status information of the engine portion 106 acquired from the paper sensor, the ink tank type discrimination sensor, and the like is notified to the image data processing block 213 of the controller portion 105. The ink tank type discrimination sensor determines the type of ink, either the pigment ink or the dye ink, loaded based on the shape of the ink tank. The result of this discrimination is notified as status information to the controller portion 105 from the CPU.

The engine portion 106 according to the first embodiment of the present invention performs two operations. In one, the carriage, on which the printing head is mounted, is moved in the main scanning direction, thereby letting the printing head print the image. In the other, the transport motor is used to transport the printing medium in a sub-scanning direction that is orthogonal to the main scanning direction. The engine portion 106 alternately and repeatedly performs these two operations to print the image sequentially in a printing area of the printing medium. If a roll of paper is used as the printing medium, the cutter comes into play to cut the paper to a predetermined length. In addition to such a type that is what is called a serial scan type, the engine portion 106 may be what is called a full line type. The full line type uses a printing head long enough to extend across the entire width of the printing area of the printing medium to accomplish printing. As the printing head, an ink jet printing head capable of ejecting ink can be used. The ink jet printing head may be a type that uses an electrothermal converter (a heater) or a piezoelectric device to eject ink. The printing head using the electrothermal converter uses thermal energy the electrothermal converter generates to boil the ink. A bubbling energy generated at this time is used to eject ink droplets from a nozzle.

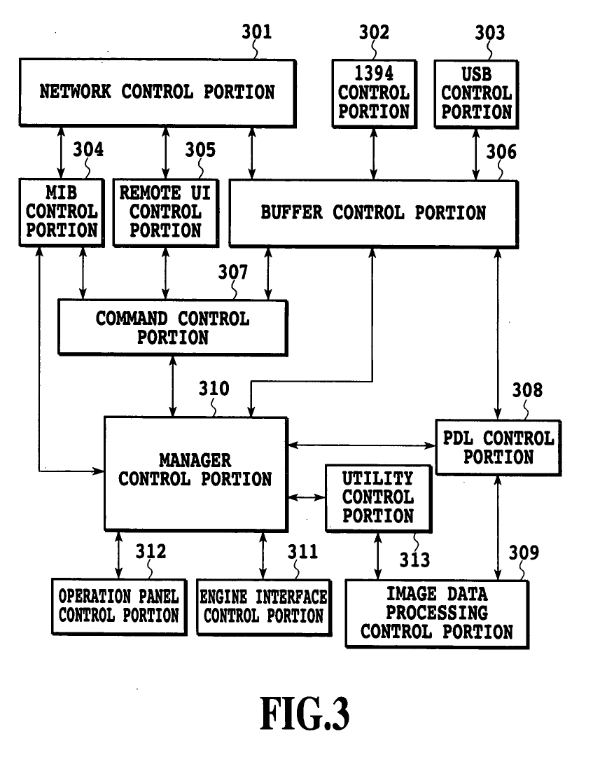

FIG. 3 is a block diagram showing a configuration of a control program operating on the CPU 201 of the controller portion 105. The control program runs on a multitasking operation system (OS).

A network control portion 301 transmits and receives data over the communication bus by controlling a LAN controller 207 (see FIG. 2). The network control portion 301 thereby controls communications protocols to be described later on a level higher than the network layer of the OSI (Open Systems Interconnection) model (the IP (Internet protocol) layer in TCP/IP (Transmission Control Protocol/Internet Protocol), the IPX (Internet Pocket Exchange) layer in NetWare, and the DDP (Datagram Delivery Protocol) layer in AppleTalk). The network control portion 301 first receives the printing job data by LPR (Line PRinter daemon protocol;TCP/IP), Bindary Pserver (Bindery Print Server;NetWare), NDSPserver (Novell Distributed Print Services server;NetWare), NPrinter (NetWare Printer;Netware), RPrinter (Remote Printer;NetWare), and PAP (Password Handshake Authentication Protocol; AppleTalk) and notifies a buffer control portion 306 of a start of connection, writes the printing job data therein, and notifies an end of connection thereto. In another channel, the network control portion 301 transmits and receives control commands by UDP (User Datagram Protocol), IPX, and DDP (AppleTalk) and writes the control commands in the buffer control portion 306, reads data sent in response thereto, and reads notification data sent from the apparatus side. In still another channel, the network control portion 301 transmits and receives data by SNMP (Simple Network Management Protocol), and performs internal processing for inquiries made concerning the control commands and information controlled by the network control portion 301 itself. For any inquiry concerning the control commands and information controlled by another control portion, the network control portion 301 calls up an MIB (Management Information Base) control portion 304. If notification data from the apparatus side (SNMP Trap) occurs, the MIB control portion 304 calls up the network control portion 301. In a further channel, the network control portion 301 transmits and receives data by HTTP (Hyper Text Transfer Protocol), and performs internal processing for inquiries made concerning the control commands and information controlled by the network control portion 301. For any inquiry concerning the control commands and information controlled by another control portion, the network control portion 301 calls up a remote UI (User Interface) control portion 305.

A 1394 control portion 302 transmits and receives data over the communication bus and controls protocols higher in a hierarchy than the transaction layer of IEEE 1394 by controlling an IEEE 1394 interface 205 (see FIG. 2). A plurality of logic channels are provided for connection to the host computer 102 by means of an IEEE 1394.3, thereby allowing reception of the printing job data to be carried out on a channel separate from that over which transmission and reception of control commands are carried out. For the buffer control portion 306, the 1394 control portion 302 notifies the start of the printing job data, writes the printing job data, notifies the end of the printing job data, writes the control command, and reads data sent in response thereto.

A USB control portion 303 transmits and receives data over the communication bus by controlling the USB interface 204. The USB control portion 303 provides a plurality of logic channels for connection to the host computer 102 by means of an IEEE 1284.4, thereby allowing reception of the printing job data to be carried out on a channel separate from that over which transmission and reception of control commands are carried out. For the buffer control portion 306, the USB control portion 303 notifies the start of the printing job data, writes the printing job data, notifies the end of the printing job data, writes the control command, and reads data sent in response thereto.

The MIB control portion 304 is called up by the network control portion 301 and calls up a command control portion 307 to make an inquiry of maintenance of the apparatus or an inquiry of status information. In addition, the MIB control portion 304 is also called up by a manager control portion 310 in order to transmit the notification data (SNMP Trap) from the apparatus side. The MIB control portion 304 calls up the network control portion 301 and transmits the notification data to the host computer 102.

A remote UI control portion 305, called up by the network control portion 301, calls up the command control portion 307 to make an inquiry of maintenance of the apparatus or an inquiry of status information.

The buffer control portion 306 controls a printing job data buffer, a reception buffer and a reply buffer for control commands provided for each interface (the network control portion 301, the 1394 control portion 302, and the USB control portion 303), and a notification buffer used for notification made from the apparatus side. For the printing job data buffer, authority to write is granted for a single interface by the notice of the start of the printing job data. Exclusive processing of other interfaces is then executed until the end of the printing job data is notified by that particular single interface. The manager control portion 310 monitors a use condition of the printing job data buffer. If the use remains stagnant for a predetermined period of time during a period from the start to end of the job data, the manager control portion 310 notifies a timeout, forcibly terminating the job data. The printing job data written by each of different interfaces is read by the command control portion 307 and a PDL (Page Description Language) control portion 308.

The printing job data transmitted from the host computer is composed of a command data portion and a PDL data portion. When the command control portion 307 reading the command data portion notifies a PDL data start, the authority to read a buffer is granted for the PDL control portion 308 reading the PDL data portion. When the PDL control portion 308 notifies a PDL data end, on the other hand, the authority to read a buffer is granted for the command control portion 307. Exclusive processing is mutually performed. Each of different interfaces writes data in the reception buffer for control commands. The command control portion 307 reads control commands from the reception buffers for all interfaces. The command control portion 307 then writes reply data for these control commands in the transmission buffer. Each host interface control portion then reads the reply data and transmits the same to the communication bus 101. Further, each host interface control portion reads the notification data written in the notification buffer from the command control portion 307 and transmits the same to the communication bus 101.

The command control portion 307 controls the information concerning the printing jobs in the apparatus, information concerning the status of the apparatus (including static information such as the name of the apparatus and the like), and the information concerning the notification recipient. Specifically, the command control portion 307 performs the following operations: reading the command data portion of the printing job data from the buffer control portion 306; generating the printing job; setting the printing specifications parameters for the job; and notifying the buffer control portion 306 of the PDL data start. In addition, the command control portion 307 notifies the manager control portion 310 of the start and end of the job data. When notifying the PDL data start, the command control portion 307 notifies the manager control portion 310 of the printing specifications parameters for the job being processed. The printing specifications parameters include information indicating the type of the printing medium. Further, the command control portion 307 reads the control command from the buffer control portion 306 and, if the control command read constitutes an inquiry about the information on the status of the printing job or the apparatus, writes reply data in the buffer control portion 306. If the control command read is concerned with maintenance of the apparatus, the command control portion 307 notifies the manager control portion 310 of the requirement and writes the result of execution of the maintenance as reply data in the buffer control portion 306.

If the control command is an inquiry about the information on the status of the printing job or the apparatus, with the command control portion 307 being called up from the MIB control portion 304 or the remote UI control portion 305, the command control portion 307 returns reply data to the MIB control portion 304 or the remote UI control portion 305. If the control command is for the maintenance of the apparatus, the command control portion 307 notifies the manager control portion 310 of the command and returns the result of execution as reply data to the MIB control portion 304 or the remote UI control portion 305. If the control command is one for filing or deletion with the host computer 102 as the notification recipient, the command control portion 307 updates the information on the notification recipient and writes the result thereof in the buffer control portion 306.

The command control portion 307 is called up by the manager control portion 310 if there is any change in the condition of the apparatus, updating the information on the printing job and on the status of the apparatus. At this time, the command control portion 307 writes notification data in the buffer control portion 306 so that the notification of the change in the condition may be made to the host computer 102 filed as the notification recipient. The information updated from the manager control portion 310 includes information indicating the result of determination made whether the ink tank loaded in the printing portion is for the dye ink or the pigment ink. The information notified to the host computer 102 includes the name of the apparatus, to which the result of determination is appended.

The PDL control portion 308 reads the PDL data portion of the printing job data from the buffer control portion 306 and interprets a PDL (Page Description Language) including the printing specifications parameters, the color conversion table, and image information. The PDL control portion 308 notifies the manager control portion 310 of the start and end of processing for each page. In addition, the PDL control portion 308 also notifies the manager control portion 310 of the printing specifications parameters to acquire the printing control parameters and then notifies an image data processing control portion 309 of the printing control parameters. The PDL control portion 308 expands the image information described in the PDL to dot data and writes the dot data, together with the color conversion table, to the image data processing control portion 309. The printing specifications parameters notified to the manager control portion 310 include information indicating the type of the printing medium.

The image data processing control portion 309 controls the image data processing block 213 (see FIG. 2) to perform image information conversion processing and transmits the dot data to the engine portion 106. The image data processing control portion 309 first transmits the printing control parameters notified from the PDL control portion 308 to the engine. Based on the color conversion table written by the PDL control portion 308, the image data processing control portion 309 translates the dot data written thereto to the corresponding dot data of each of different ink colors. In addition, the image data processing control portion 309 processes the dot data for conversion from multiple gradation levels to binary levels and, at the same time, performs resolution conversion. The binary dot data obtained for each of different ink colors through the processing noted above is then transmitted to the engine so that the engine portion 106 performs printing of the image information.

The manager control portion 310 controls the information on the job being processed and on the status of the apparatus. The manager control portion 310 also monitors the printing job data buffer of the buffer control portion 306 and notifies a timeout. The manager control portion 310 receives notification of the start and the end of the job data from the command control portion 307 and notification of the start and the end of processing for each page from the PDL control portion 308. The manager control portion 310 receives notification of the printing specifications parameters from the command control portion 307 and the PDL control portion 308 and notifies the PDL control portion 308 of the printing control parameters selected based on specific details of the notification. Further, the manager control portion 310 receives a control command for maintenance or an operation command from the command control portion 307 or an operation panel control portion 312. If the command received is test printing, the manager control portion 310 calls up a utility control portion 313. If the command received is to be executed by the engine portion 106, the manager control portion 310 calls up an engine interface control portion 311.

Being notified of the status information from the engine interface control portion 311, the manager control portion 310 updates the information on the job being processed and on the status of the apparatus. If there are any changes involved, the manager control portion 310 calls up the command control portion 307, the MIB control portion 304, and the operation panel control portion 312 to pass the status change information. The status information notified by the engine interface control portion 311 includes information indicating that the printing medium has been loaded in the paper feeding portion and the result of determination made as to whether the ink tank loaded in the printing portion is for the pigment ink or the dye ink.

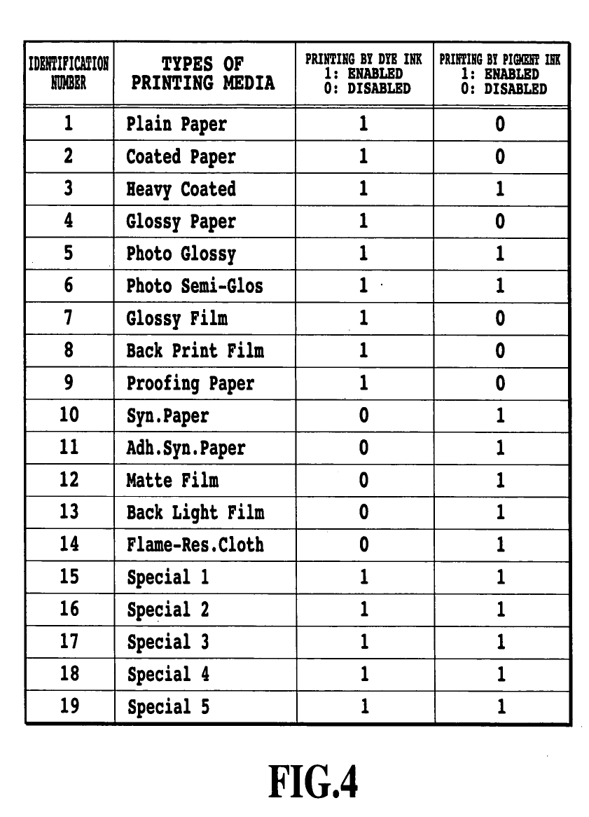

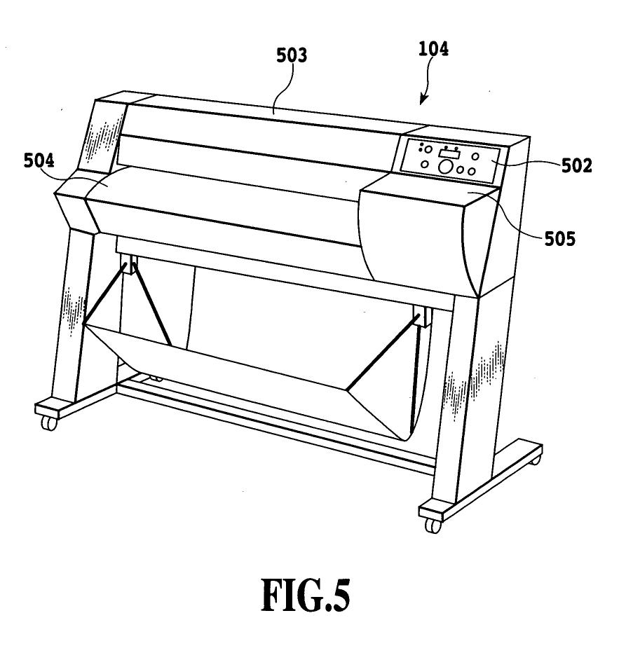

FIG. 4 shows a table retained by the manager control portion 310, indicating applicability between the different types of printing media and different types of ink (printing materials). The manager control portion 310 stores in memory information on whether or not printing by the dye ink is possible (1 or 0) and whether or not printing by the pigment ink is possible (1 or 0) for each of different types of printing media as identified by an identification number assigned to each of the different types of printing media. When notified that the printing medium has been loaded in the paper feeding portion, the manager control portion 310 controls the operation panel control portion 312, as described later, to let the user set the type of the printing medium loaded in the paper feeding portion.

The engine interface control portion 311 shown in FIG. 3 controls the image data processing block 213 (see FIG. 2) and notifies the manager control portion 310 of the status information notified from the engine portion 106. The engine interface control portion 311 also makes an inquiry about status at the engine portion 106 as called up by the manager control portion 310. Meanwhile the engine interface control portion 311 notifies the engine portion 106 of the execution of the control command for maintenance. The status information informed to the manager control portion 310 includes information indicating that the printing medium has been loaded in the paper feeding portion and the result of determination made as to whether the ink tank loaded in the printing portion is for the pigment ink or the dye ink.

The operation panel control portion 312 controls the operation panel interface 211 (see FIG. 2) and controls LED indications and the LCD display given on the operation panel 212 according to the command information input through keys on the operation panel 212 and the status of apparatuses informed by the manager control portion 310. In addition, the operation panel control portion 312 also calls up the manager control portion 310 in order to issue operation commands for maintenance of the apparatus or a status inquiry according to the command information.

To execute test printing notified by the manager control portion 310, the utility control portion 313 makes an inquiry at the manager control portion 310 about the status information on the apparatus on which the printing is executed. The utility control portion 313 creates dot data and writes the dot data in the image data processing control portion 309.

The table shown in FIG. 4 indicating the applicability between the different types of printing media and different types of ink (printing materials) will be described. In accordance with the first embodiment of the present invention, the type of printing medium that can be used is appropriately restricted according to the type of ink as shown in FIG. 4 in order to prevent a printing medium not suitable for the ink (either the pigment ink or the dye ink) from being inappropriately selected.

For back print film, for example, it is not preferred to use the pigment ink for the reason to be described later and only the dye ink is to be used. To state it another way, an arrangement is made to restrict the use of back print film if the type of ink used is the pigment ink. A further arrangement is made to enable the use of back print film if the type of ink used is the dye ink.

The reason why the use of the pigment ink is not preferred for back print film will be explained. The back print film is organized as follows. Specifically, an ink receiving layer is provided on one side of a substrate of the back print film and the surface on which the ink receiving layer is provided is designated as a printing surface. A side opposite to the printing surface is designated as an observation surface. If the pigment ink is driven into the ink receiving layer of the back print film organized as described above, pigment particles do not enter deeply into the ink receiving layer because of their particle size involved, getting stagnant in a location near the surface of the ink receiving layer. That is, almost all of the pigment particles do not penetrate through the ink receiving layer to reach the side (the observation surface) opposite to the printing surface. This results in the image density as observed from the observation surface being not sufficient, and a good image quality cannot be obtained. Since a sufficient image density cannot be obtained from the pigment ink driven into the back print film as described above, the use of the back print film is restricted with respect to the pigment ink to be used as the type of ink according to the first embodiment of the present invention.

For syn. paper (synthetic paper), as another example, the use of the dye ink is not preferred for the reason to be described later and only the pigment ink is used. To state it another way, an arrangement is made to restrict the use of syn. paper if the type of ink used is the dye ink. A further arrangement is made to enable the use of syn. paper if the type of ink used is the pigment ink.

The reason why the use of the dye ink is not preferred for the syn. paper will be explained. The syn. paper is a printing medium (termed “YUPO” in the art) made mainly of polypropylene resin. The syn. paper is highly resistant to moisture and hard to break, and is also resistant to acid, alkali, organic solvent, oil, and the like. Common applications of the syn. paper therefore include posters posted outdoors, publications, and others in need of weathering resistance. For these applications, the pigment ink that is superior in weathering resistance should be used. If the dye ink that is inferior in weathering resistance is used for printing, it is not possible to obtain sufficient weathering resistance. Since a sufficient weathering resistance corresponding to the printing medium cannot be obtained from the dye ink driven into the syn. paper as described above, the use of the syn. paper is restricted with respect to the dye ink to be used as the type of ink according to the first embodiment of the present invention.

For photo glossy, as still another example, the use of the pigment ink or the dye ink does not present any specific unfavorable problem. The use of either type of the ink is therefore allowed. To state it another way, an arrangement is made not to restrict the use of the photo glossy regardless of whether the type of ink used is the dye ink or the pigment ink, thus enabling-the use of either type of ink for the photo glossy.

FIG. 5 is an external view showing the printer 104. The printer 104 is connected to the host computer 102 through the USB interface, IEEE 1394 interface, or Ethernet (a registered trademark) interface connector by way of the communication cable. The user loads a roll of paper, as the printing medium to be used for printing, in a roll paper tray by opening a roll paper cover 504, or loads cut sheets, as the printing medium to be used for printing, manually on a manual bypass tray by opening a main body upper cover 503. On receipt of a printing job, the printer 104 causes the transport motor not shown and located inside the main body upper cover 503 to transport the roll paper or cut sheet to accomplish a printing operation through the use of the printing head not shown. An ink tank accommodating ink of each of different colors not shown is loaded inside an ink tank cover 505. The shape of the ink tank is made different between one for storing the pigment ink and one for storing the dye ink, thereby allowing an ink tank for the pigment ink to be discriminated from an ink tank for the dye ink.

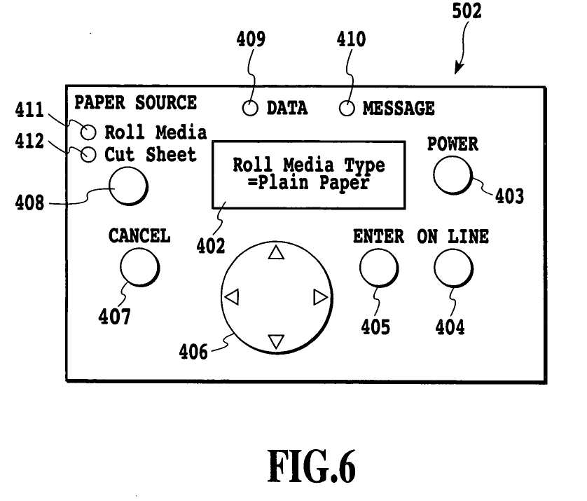

FIG. 6 is an external view showing an operation panel 502 of the printer 104. When the engine interface control portion 311 notifies the manager control portion 310 that a printing medium has been loaded in the paper feeding portion, the operation panel 502 allows the user to set the type of the printing medium loaded in the paper feeding portion. Specific control details of the operation panel control portion 312 will be explained based on the details of what is displayed in a LCD 402 of the operation panel 502.

When the printing medium is loaded in the roll paper tray or the manual bypass tray of the printer 104, the LCD 402 on the operation panel 502 displays a character string representing the type of the printing medium. The type of the printing medium displayed in the LCD 402 is the type of the printing medium stored in the table shown in FIG. 4, which the manager control portion 310 retains, limited to ones that can be printed using the ink (printing material) loaded in the printer 104. If the dye ink is loaded, for example, only the types of printing media on which printing is enabled (1), as indicated in the column of the table of FIG. 4 indicating whether printing is enabled “1” or disabled “0” using the dye ink, are displayed. The user can change the type of the printing medium displayed by pressing an upper portion or a lower portion of an arrow key 406 of the operation panel 502.

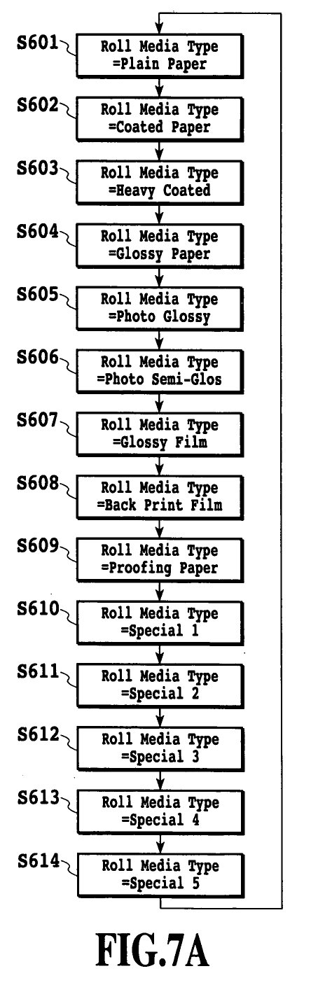

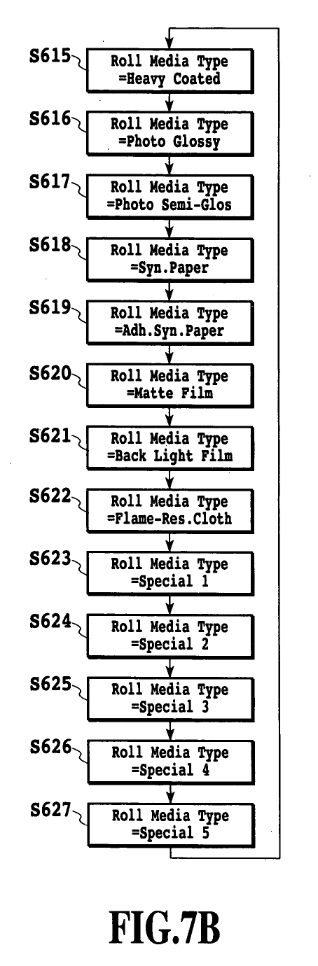

If, for example, the LCD 402 displays “Plain Paper” as in step S601 of FIG. 7A, pressing the lower portion of the arrow key 406 will display “Coated Paper” as in step S602 and pressing the upper portion of the arrow key 406 will display “Special 5” as in step S614. Specifically, each press of the lower portion of the arrow key 406 from the condition of the display as in step S601 will change the display in the order of step S602, S603, S604, S605, S606, S607, S608, S609, S610, S611, S612, S613, S614, and S601, and repeated thereafter in this order. Similarly, each press of the upper portion of the arrow key 406 from the condition of the display as in step S601 will change the display in the order of step S614, S613, S612, S611, S610, S609, S608, S607, S606, S605, S604, S603, S602, and S601, and repeated thereafter in this order.

If the pigment ink is loaded, on the other hand, only the types of printing media on which printing is enabled (1), as indicated in the column of the table of FIG. 4 indicating whether printing is enabled “1” or disabled “0” using the pigment ink, are displayed. For example, each press of the lower portion of the arrow key 406 from the condition of the display as in step S615 shown in FIG. 7B will change the display in the order of step S616, S617, S618, S619, S620, S621, S622, S623, S624, S625, S626, and S627, and repeated thereafter in this order. Similarly, each press of the upper portion of the arrow key 406 from the condition of the display as in step S615 will change the display in the order of step S627, S626, S625, S624, S623, S622, S621, S620, S619, S618, S617, and S616, and repeated thereafter in this order.

The user can then validate the type of the printing medium being displayed in the LCD 402 as the type of the printing medium loaded in the printer 104 by pressing an enter key 405 on the operation panel 502. The manager control portion 310 retains the type of the printing medium validated herein as the type of the paper loaded in the roll paper tray or the manual bypass tray.

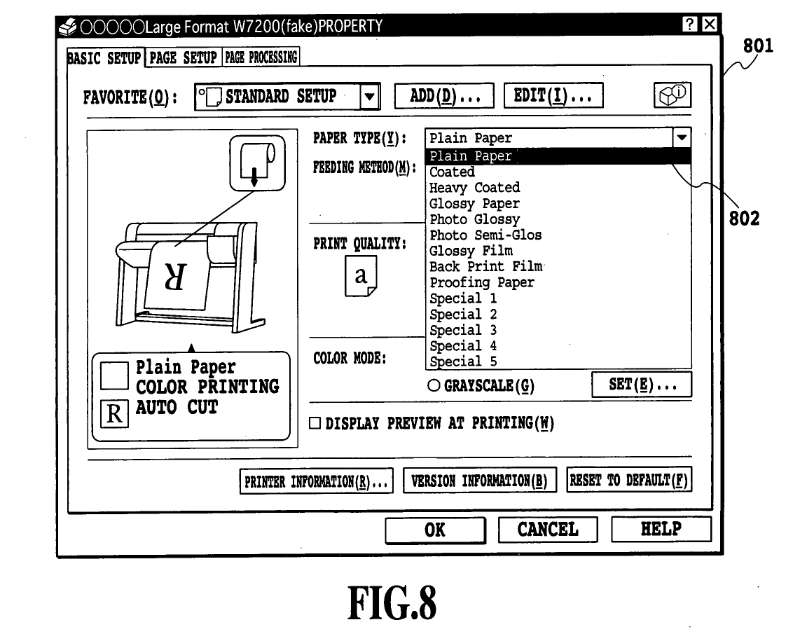

FIG. 8 is a typical dialog displayed by a printer driver running on the host computer 102. The utility that runs also on the host computer 102 makes an inquiry about the name of the apparatus of the printer 104 by using the control command. The utility thereby determines if the ink tank loaded in the printing portion of the printer 104 is for the dye ink or for the pigment ink and notifies the printer driver of the result of the determination. The printer driver retains a table equivalent to the table shown in FIG. 4 retained by the manager control portion 310 of the printer 104. The printer driver can determine the applicability between the type of the ink (printing material) and the type of printing medium that can be used therefor. When allowing the user to select the type of the printing medium to print data on by displaying the dialog for printing, the printer driver displays in a box 802 only the type of the printing medium that can be used for the ink (printing material) notified by the utility.

FIG. 8 represents an example of a display given when the printing portion of the printer 104 uses the dye ink. Only the types of the printing media on which printing is enabled “1”, as indicated in the column of the table of FIG. 4 indicating whether printing is enabled “1” or disabled “0” using the dye ink, are displayed in the box 802. When the user select the printing medium used for printing from among those displayed in the box 802, a printing parameter is set and the printing job data is transmitted to the printer 104.

### Second Embodiment

A printing apparatus according to a second preferred embodiment of the present invention differs from the printing apparatus according to the first preferred embodiment of the present invention in the method of controlling the operation panel control portion 312 by the manager control portion 310 when a printing medium is loaded in the paper feeding portion. An information processing apparatus according to the second preferred embodiment of the present invention differs from the information processing apparatus according to the first preferred embodiment of the present invention in the display of the printer driver dialog.

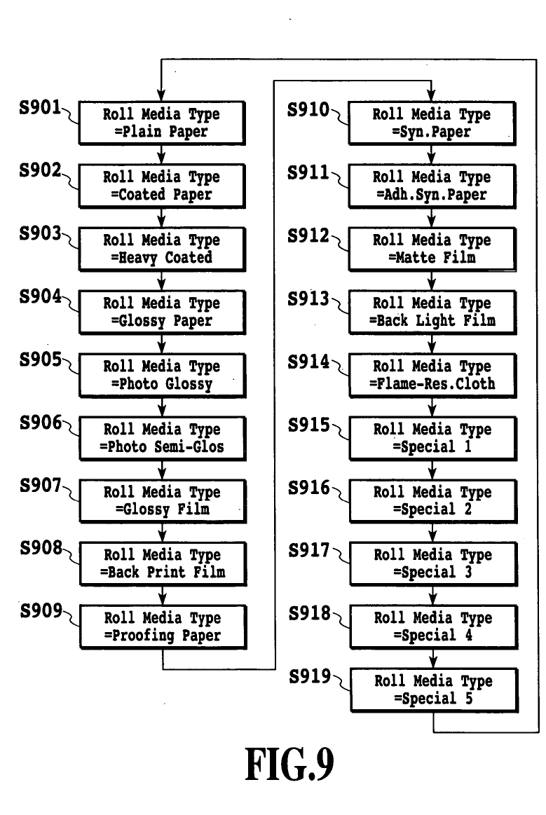

Specifically, in accordance with the second preferred embodiment of the present invention, the types of printing media displayed in the LCD 402 of the operation panel 502 when a printing medium is loaded in the roll paper tray or the manual bypass tray are all types of printing media stored in the table shown in FIG. 4 retained by the manager control portion 310, regardless of whether the printing portion of the printer 104 uses the dye ink or the pigment ink. If, for example, “Plain Paper” is displayed in the LCD 402 as shown in step S901 of FIG. 9, pressing the lower portion of the arrow key 406 will display “Coated Paper” as shown in step S902 and pressing the upper portion of the arrow key 406 will display “Special 5” as shown in step S919. Specifically, each press of the lower portion of the arrow key 406 from the condition of the display as in step S901 will change the display in the order of step S902, S903, S904, S905, S906, S907, S908, S909, S910, S911, S912, S913, S914, S915, S916, S917, S918, S919, and S901, and repeated thereafter in this order. Similarly, each press of the upper portion of the arrow key 406 from the condition of the display as in step S901 will change the display in the order of step S919, S918, S917, S916, S915, S914, S913, S912, S911, S910, S909, S908, S907, S906, S905, S904, S903, S902, and S901, and repeated thereafter in this order.

The user can then validate the type of the printing medium being displayed in the LCD 402 as the type of the printing medium loaded in the printer 104 by pressing the enter key 405 on the operation panel 502. If a printing medium that cannot use the ink (printing material) loaded for use is selected at this time, a warning display is given in the LCD 402. When the upper portion or the lower portion of the arrow key 406 is thereafter pressed, the display allowing the user to select the type of the printing medium reappears. When the type of the printing medium that can use the ink (printing material) currently loaded for use is then selected, that particular type of the printing medium is validated as the type of the printing medium loaded in the printer 104. If the enter key 405 is pressed again when the warning display is given in the LCD 402, the type of the printing medium is forcedly validated. To explain this in further details, the fact that the same printing medium is selected a second time despite the warning display indicates that the user is very likely to want to have an output produced on that specific type of the printing medium. In such cases, a printing medium not suitable for use with the ink (printing material) used for printing, should it be selected for the printing medium, is validated for use.

The printer driver running on the host computer 102 displays in the box 802, as the printer driver gives a dialog for effecting printing, all types of printing media stored in the table shown in FIG. 4 retained by the printer driver. The user selects the type of printing medium for use in printing from among those displayed in the box 802. If the user selects, at this time, a type of printing medium that defies the use of the ink (printing material) loaded in the printing portion of the printer 104 notified by the aforementioned utility, the printer driver gives a warning display in the dialog. The user may opt to ignore the warning and validate the type of printing medium as the printing specifications parameter. The user can still display the box 802 for selection of the printing medium once again and reselect the printing medium.

### Third Embodiment

In accordance with the first and the second embodiments of the present invention, the types of printing materials to be selectively used are the pigment ink and the dye ink. The present invention is not, however, limited to such applications. For example, the types of printing materials to be selectively used may be a thick ink and a thin ink. Or, the types are ink having a low infiltration capacity and ink having a high infiltration capacity.

An arrangement in which the thick ink and the thin ink are selectively used will be described as a first example. The thick ink as the term is used herein refers to a type of ink having a relatively high concentration of dye, pigment, or other coloring material. The thin ink refers to a type of ink having a relatively low concentration of dye, pigment, or other coloring material. With OHP transparencies not disclosed in FIG. 4, for example, use of the thin ink only for printing yields unfavorable results for a reason to be described later. An arrangement is therefore provided for restricting the use of OHP transparencies if the type of ink used is the thin ink. An arrangement is further made to enable the use of OHP transparencies if the thick ink is used for the type of ink.

The reason why it is not preferred to use only the thin ink for printing on OHP transparencies will be explained. The thin ink yields a low printing density. To obtain an image having a high image density, therefore, it is necessary to eject droplets of the thin ink, one on top of another. Ejecting droplets of thin ink one on top of another will increase the image density, allowing an image of a high image density to be obtained. Driving a large amount of ink into a printing medium having a poor ink absorbing capacity, such as OHP transparencies, causes an “ink overflow” to occur, as the printing medium is unable to fully absorb the ink. As explained in the foregoing, an ink overflow results if only the thin ink is driven into the OHP transparencies. For this reason, the use of the OHP transparencies is restricted if the type of ink used is the thin ink according to the third embodiment of the present invention. In the meantime, the thick ink yields a high printing density even without ejecting droplets of thick ink one on top of another. It is not therefore necessary to eject droplets of thick ink one on top of another to obtain a high image density. If the thick ink is selected as the type of ink used, therefore, the use of OHP transparencies is allowed.

An arrangement in which the ink having a low infiltration capacity and the ink having a high infiltration capacity are selectively used will be described as a second example. The ink having a low infiltration capacity as the term is used herein refers to a type of ink that has a relatively low infiltration rate with respect to the printing medium. The ink having a high infiltration capacity, on the other hand, refers to a type of ink that has a relatively high infiltration rate with respect to the printing medium.

With the OHP transparencies not disclosed in FIG. 4, for example, use of the ink having a low infiltration capacity only for printing yields unfavorable results for a reason to be described later. An arrangement is therefore provided for restricting the use of OHP transparencies if the type of ink used is the ink having a low infiltration capacity. An arrangement is further made to enable the use of OHP transparencies if the type of ink used is the ink having a high infiltration capacity.

The reason why it is not preferred to use only the ink having a low infiltration capacity for printing on OHP transparencies will be explained. When the ink having a low infiltration capacity is driven into a printing medium having a poor ink absorbing capacity, such as OHP transparencies, a plurality of different types of ink are mixed together with each other on the surface of the sheet, thus degrading the image quality, before the ink infiltrates deeply into the OHP transparencies. Especially when the plurality of different types of ink mixed together are of different colors from each other, the resultant image is a mixture of different colors. As explained in the foregoing, a degraded image quality or a mixture of colors results if only the ink having a low infiltration capacity is driven into the OHP transparencies. For this reason, the use of the OHP transparencies is restricted if the type of ink used is the ink having a low infiltration capacity according to the third embodiment of the present invention.

### Other Embodiments

It may be arbitrarily decided which portions of the functional blocks shown in FIGS. 1 to 3 are to be implemented using a hardware circuit or software processing using a computer. It is also possible to provide these functional blocks for the printer (printing apparatus) or the host computer (information processing apparatus), or both as the functional blocks are appropriately separated.

If the user selects the type of printing medium to be applied to a printing material used for printing, the information on the type of the printing medium selected by the user may be used for setting the printing control parameters and the like. If the type of the printing medium selected on the printer side does not coincide with the type of the printing medium set in the printer driver on the host computer side, as found through a comparison made between the two, an arrangement may be provided for issuing a warning using a display screen or the like.

As described in the foregoing, the present invention may be applied to a system composed of a plurality of apparatuses (for example, a host computer, an interface apparatus, a reader, a printer, and the like). Or, the present invention may be applied to an apparatus that is made up of a single device (for example, a copying machine, a facsimile machine, and the like).

To achieve the functions in accordance with the preferred embodiments of the present invention described in the foregoing, program codes of software implementing the functions in accordance with the preferred embodiments of the present invention may be supplied to a computer within an apparatus or a system connected to different types of devices. In this case, the different types of devices are operated according to the program stored in the computer (including a CPU or an MPU) of the apparatus or system. Such an embodiment is also covered by the scope of the present invention.

In this case, the functions of the embodiments according to the present invention described in the foregoing are implemented by the program codes themselves of the software. As a result, the program codes themselves, and means of supplying the computer with the program codes, for example, a storage medium storing the program codes, comprise the present invention.

As the storage medium storing the program codes, a floppy (a registered trademark) disk, a hard disk, an optical disk, an optical magnetic disk, a CD-ROM, a magnetic tape, a nonvolatile memory card, a ROM, and the like may, for example, be used.

The functions of the preferred embodiments according to the present invention described in the foregoing are implemented when the computer executes the program codes supplied thereto. In addition, the aforementioned functions of the preferred embodiments according to the present invention can be implemented by the program codes working in cooperation with the OS (operating system) running in the computer or other application software or the like running therein. It goes without saying that, in such cases, too, the program codes are included in the scope of the present invention.

Further, the program codes supplied may first be stored in a memory provided in a function expansion board of the computer or a function expansion unit connected to the computer and then the CPU or the like provided in the function expansion board or the function expansion unit performs part or all of the actual processing in accordance with the instructions given by the program codes. It goes without saying that the arrangement, in which the aforementioned functions of the preferred embodiments according to the present invention are implemented by the processing mentioned above, is also covered by the scope of the present invention.

The present invention has been described in detail with respect to preferred embodiments, and it will now be apparent from the foregoing to those skilled in the art that changes and modifications may be made without departing from the invention in its broader aspect, and it is the intention, therefore, in the apparent claims to cover all such changes and modifications as fall within the true spirit of the invention.

What is claimed is:

1. A printing apparatus capable of printing an image on printing media of a plurality of types by selectively using printing materials of a plurality of types, comprising:
a discrimination portion for discriminating the type of said printing material used for printing of an image;
a storage portion for storing information on applicability between different types of said printing materials and different types of said printing media; and
a collation portion for collating the type of said printing material discriminated by said discrimination portion with information stored in said storage portion.

2. A printing apparatus according to claim 1, further comprising:
an input portion for allowing an input to be made of the type of said printing medium used for printing of an image, wherein
said collation portion collates a combination of the type of said printing medium input through said input portion and the type of said printing material discriminated by said discrimination portion with information on applicability stored in said storage portion.

3. A printing apparatus according to claim 2, further comprising:
a medium feeding portion for allowing said printing medium to be loaded therein, wherein
said input portion allows the type of said printing medium loaded in said medium feeding portion to be input.

4. A printing apparatus according to claim 1, further comprising:
a selector portion for allowing the type of said printing medium used for printing of an image to be selected, wherein
said collation portion collates a combination of the type of said printing medium selected with said selector portion and the type of said printing material discriminated by said discrimination portion with information on applicability stored in said storage portion.

5. A printing apparatus according to claim 4, further comprising:
a medium feeding portion for allowing said printing medium to be loaded therein, wherein
said selector portion allows the type of said printing medium loaded in said medium feeding portion to be selected.

6. A printing apparatus according to claim 1, further comprising:
a display portion for displaying the type of said printing medium that can be used for printing of an image.

7. A printing apparatus according to claim 1, wherein
said collation portion causes the display portion to display the type of said printing medium having an applicability relation with the type of said printing material discriminated by said discrimination portion.

8. A printing apparatus according to claim 1, wherein
said collation portion causes the display portion to display only the type of said printing medium having an applicability relation with the type of said printing material discriminated by said discrimination portion and not to display the type of said printing medium having no applicability relation with the type of said printing material discriminated by said discrimination portion.

9. A printing apparatus according to claim 2, wherein
said collation portion issues a warning when there is no applicability relation between the type of said printing material discriminated by the discrimination portion and the type of said printing medium input through said input portion.

10. A printing apparatus according to claim 1, wherein
said printing material that can be used for printing of an image includes a pigment ink and a dye ink.

11. An information processing apparatus connected to a printing apparatus capable of printing an image on printing media of a plurality of types by selectively using printing materials of a plurality of types, comprising:
an input portion for allowing an input to be made of the type of said printing medium used by said printing apparatus;
a storage portion for storing information on applicability between different types of said printing materials and different types of said printing media; and
a collation portion for collating the type of said printing material input from said input portion with information stored in said storage portion.

12. An information processing apparatus according to claim 11, further comprising:
a selector portion for allowing the type of said printing medium used by said printing apparatus to be selected, wherein
said collation portion collates a combination of the type of said printing medium selected with said selector portion and the type of said printing material input from said input portion with information on applicability stored in said storage portion.

13. An information processing apparatus according to claim 11, further comprising:
a display portion for displaying the type of said printing medium that can be used in said printing apparatus.

14. An information processing apparatus according to claim 11, wherein
said collation portion causes the display portion to display the type of said printing medium having an applicability relation with the type of said printing material input from said input portion.

15. An information processing apparatus according to claim 11, wherein
said collation portion causes the display portion to display only the type of said printing medium having an applicability relation with the type of said printing material input from said input portion and not to display the type of said printing medium having no applicability relation with the type of said printing material input from said input portion.

16. A printing system including a printing apparatus capable of printing an image on printing media of a plurality of types by selectively using printing materials of a plurality of types and an information processing apparatus connected to said printing apparatus, comprising:
a discrimination portion for discriminating the type of said printing material used by said printing apparatus;
a storage portion for storing information on applicability between different types of said printing materials and different types of said printing media; and
a collation portion for collating the type of said printing material discriminated by said discrimination portion with information stored in said storage portion.

17. A method for selecting a printing medium from among a plurality of types of printing media, on which an image is printed, when printing the image by selectively using printing materials of a plurality of types, comprising the steps of:
discriminating the type of said printing material used for printing; and
displaying, as reference information for selecting said printing medium, on which the image is printed, the type of said printing medium that is adaptable at least to said type of said printing material discriminated.

18. A method for selecting a printing medium according to claim 17, wherein
a warning is issued when a type of said printing medium not adaptable to said type of said printing material discriminated is selected as said printing medium, on which the image is printed.

19. A method for selecting a printing medium according to claim 17, wherein
only said printing medium adaptable to said type of said printing material discriminated is displayed, while said printing medium not adaptable to said type of said printing material discriminated is not displayed.

20. A method for selecting a printing medium according to claim 17, wherein
said printing materials used for printing include a pigment ink and a dye ink.

21. A program for selecting a printing medium from among a plurality of types of printing media, on which an image is printed, when printing the image by selectively using printing materials of a plurality of types, comprising the processes executed by a computer of:
discriminating the type of said printing material used for printing; and
displaying, as reference information for selecting said printing medium, on which the image is printed, the type of said printing medium that is adaptable at least to said type of said printing material discriminated.

22. A program according to claim 21, wherein the computer is made to execute a process of issuing a warning when a type of said printing medium not adaptable to said type of said printing material discriminated is selected as said printing medium, on which the image is printed.

23. A program according to claim 21, wherein the computer is made to execute a process of displaying only the type of said printing medium adaptable to said type of said printing material discriminated, while not displaying the type of said printing medium not adaptable to said type of said printing material discriminated.

24. A computer-readable storage medium storing the program according to claim 21.

25. A method for printing an image on printing media of a plurality of types by selectively using printing materials of a plurality of types, comprising the steps of:
discriminating the type of said printing material used for printing;
displaying, as reference information for selecting said printing medium, on which the image is printed, the type of said printing medium that is adaptable at least to said type of said printing material discriminated;
selecting one printing medium from among the plurality of said printing media displayed by said displaying process; and
effecting printing on said printing medium selected using said printing material discriminated.
